(19) United States
(12) Patent Application Publication
(10) Pub. No.: US 2009/0122158 A1
(43) Pub. Date: May 14, 2009

(54) IMAGE CAPTURING DEVICE AND METHOD

(75) Inventor: MAN-SHENG CHEN, Fo-Shan (CN)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/141,089

(22) Filed: Jun. 18, 2008

(30) Foreign Application Priority Data
Nov. 14, 2007 (CN) 200710202541.2

(51) Int. Cl. H04N 5/76; H04N 5/232

(52) U.S. Cl. 348/231.99; 348/345; 348/E05.042

(57) ABSTRACT

An image capturing device includes a taking lens, a plurality of focus modes for capturing object with different distances, and a processing unit. The processing unit includes a receiving module, a focusing module, a determining module, a selecting module, and an image capturing module. The receiving module is configured for receiving a focus mode selected by a user. The focusing module is configured for performing auto-focus processing within the range of a focus mode selected by the user or the image capturing device automatically. The determining module is configured for determining whether the image is in focus in the selected focus mode. The selecting module is configured for selecting a correct focus mode automatically according to the auto-focus processing performed before, when the image is judged out focus. The image capturing module is configured for capturing an image in a correct focus mode.

### TECHNICAL FIELD

The present invention relates to image capturing devices and, particularly, to an image capturing device and method which can correct focus mode automatically when a user selects an wrong focus mode during image capturing.

### DESCRIPTION OF THE RELATED ART

With the ongoing development of optical imaging technology, image capturing devices are widely used in electronic devices such as still cameras and mobile phones. Most conventional image capturing devices have an auto-focus function.

In order to shorten the time for focusing, conventional image capturing devices usually have a number of focus modes corresponding to different distances. For example, a macro mode configured for photographing an object with a distance from 1 cm to 30 cm, a normal mode configured for photographing an object with an distance from 30 cm to 10 m, and an infinity mode configured for photographing an object with an distance larger than 10 m. During photographing an object, users need to select a focus mode first, and then the image capturing device will perform auto-focus for capturing an image of the object. Sometimes, the users may select an wrong focus mode, as a result, the image capturing device may not be able to focus properly at the selected focus mode and thus, unclear image is captured. In this case, the users will need to try again if they are aware of it, or may lose the chance entirely for capturing the image they wanted if they don't realize they have selected the wrong focus mode.

What is needed, therefore, is an image capturing device that can overcome the above-described shortcomings.

### SUMMARY

In accordance with one present embodiment, an image capturing device includes a taking lens, a plurality of focus modes for capturing objects at different distances from the image capturing device, a memory for storing a movement range of the taking lens corresponding to each focus mode, and a processing unit for controlling image capturing of the image capturing device. The processing unit includes a receiving module, a focusing module, a determining module, a selecting module, and an image capturing module. The receiving module is configured for receiving a focus mode selected by a user. The focusing module is configured for performing auto-focus processing within the range of a focus mode selected by the user or auto-selected by the image capturing device. The determining module is configured for determining whether the image is in focus in the selected focus mode. The selecting module is configured for selecting a correct focus mode automatically according to the auto-focus processing performed before, when the image is judged out focus. The image capturing module is configured for capturing an image in a correct focus mode selected by the user or auto-selected by the image capturing device.

### BRIEF DESCRIPTION OF THE DRAWINGS

Many aspects of the present image capturing device and related method can be better understood with reference to the following drawings. The components in the drawing are not necessarily drawn to scale, the emphasis instead being placed upon clearly illustrating the principles of the present image capturing device and related method.

FIG. 1 is a functional block diagram of an image capturing device according to an exemplary embodiment.

FIG. 2 is a flowchart of an image capturing method for an image capturing device according to the exemplary embodiment as shown in FIG. 1.

### DETAILED DESCRIPTION OF THE EMBODIMENTS

Embodiments of the present invention will now be described in detail below, with reference to the accompanying drawings.

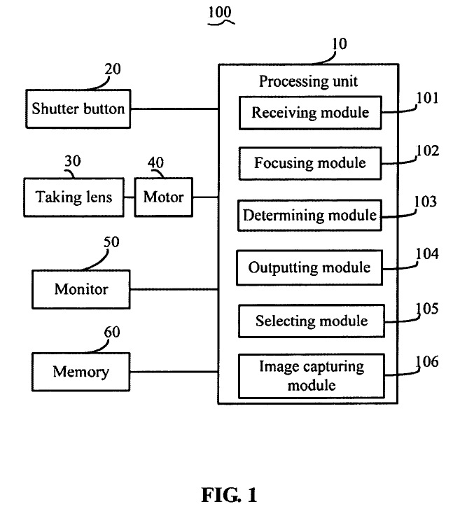

Referring to FIG. 1, an image capturing device 100, according to one exemplary embodiment, is shown. The image capturing device 100 includes a shutter button 20, a taking lens 30, a motor 40, a monitor 50, a memory 60, and a processing unit 10. The shutter 20, the motor 40, the monitor 50, and the memory 60 are electrically connected to the processing unit 10. The image capturing device 100 can for example be a still camera, a camcorder, or a mobile phone with image capturing function. The image capturing device 100 is capable of capturing images of a object at different distances using a number of focus modes accordingly. In the present embodiment, the focus modes include a macro mode, a normal mode, and an infinity mode. The macro mode is for focusing on an object from about 1 to about 30 centimeters (cm) away. The normal mode is for focusing on an object from about 30 cm to about 10 meters (m) away. The infinity mode is for focusing on an object more than 10 m away.

The shutter button 20 is a two-stage switch for triggering the image capturing function. When the shutter button 20 is pressed about half way in, auto focusing of the image capturing device 100 is performed. When the shutter button 20 is fully pressed (all the way in), the image capturing function of the image capturing device 100 is performed.

The taking lens 30 can include many lenses. These lenses are typically divided into several lens groups. The motor 40 is configured for moving the taking lens 30 back or forth under control of the processing unit 10. The monitor 50 is configured for displaying images and/or operation information of the image capturing device 100.

The memory 60 stores a movement range of the taking lens 30 corresponding to each focus mode of the image capturing device 100. The memory 60 can also be used for storing images captured by the image capturing device 100.

The processing unit 10 includes a receiving module 101, a focusing module 102, a determining module 103, an outputting module 104, a selecting module 105, and a image capturing module 106.

The receiving module 101 is configured for receiving a present focus mode selected by a user.

The focusing module 102 is configured for performing auto-focus processing within the constraints of the focus mode selected by the user. Specifically, the focusing module 102 will obtain the movement range of the taking lens 30 corresponding to the selected focus mode first, and then control the motor 40 to drive the taking lens 30 within that range when focusing.

The determining module 103 is configured for determining whether the current object can be focused on using the user selected focus mode. Generally, if the contrast of an image sensed by the image capturing device 100 increases or decreases continuously when the taking lens 30 moves through the movement range of a focus mode, the in-focus position of the taking lens 30 can be deemed as being outside the movement range of the current focus mode. If the contrast of an image sensed by the image capturing device 100 first increases and then decreases, the in-focus position (the transition point between increasing and decreasing) of the taking lens 30 can be determined as being inside the movement range of the focus mode.

The outputting module 104 is configured for displaying focus failure information on the monitor 50, if the current object is determined out focus. For example, the outputting module 104 can display words “focus failure” on the monitor 50, or change the color of a focus frame of the image capturing device 100 to red or yellow, and so on.

The selecting module 105 is configured for selecting a correct focus mode automatically according to the auto-focus processing performed before, when there is a focus failure. During the auto-focus process, a trend line of the changing contrast of the image can be obtained. The correct focus mode can be obtained according to analysis of the trend line. For example, if the normal mode is the selected mode, and in the normal mode, the contrast of the image becomes higher and higher when the taking lens moves towards the movement range of the macro mode, the macro mode can be considered as the correct focus mode.

The focusing module 102 is also configured for performing auto-focus processing in the focus mode automatically selected by the image capturing device 100.

The image capturing module 105 is configured for capturing an image in the correct focus mode. The captured image can be stored into the memory 60.

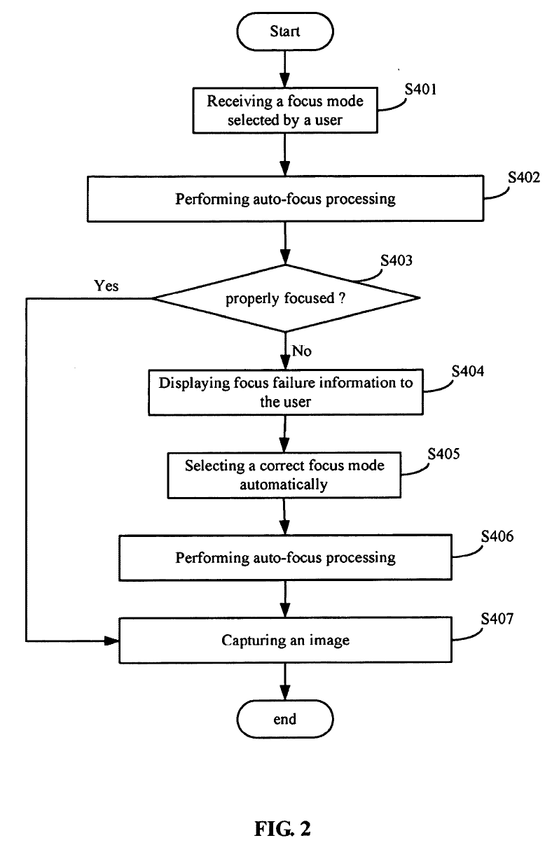

Referring to FIG. 2, a flowchart of an image capturing method for the image capturing device 100 is shown. The method includes following steps.

Step S401, receiving a focus mode selected by a user. The focus mode can be selected from, for example, a macro mode, a normal mode, or an infinity mode.

Step S402, performing auto-focus processing in the focus mode selected by the user.

Step S403, determining whether the image capturing device 100 is properly focused on a object in the selected focus mode. If the object is in focus, then the image capturing device 100 performs step S407. If the object is out focus, then the image capturing device 100 performs step 404.

Step S404, displaying focus failure information. For example, the words “focus failure” is displayed on the monitor 50, or the color of a focus frame of the image capturing device 100 is changed to red or yellow.

Step S405, selecting a correct focus mode automatically according analysis done by the selecting module 105.

Step S406, performing auto-focus processing in the focus mode automatically selected by the step 405.

Step S407, capturing an image. In the present embodiment, image capture by the image capturing device 100 is performed when a user fully-presses the shutter button 20.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. An image capturing device, capable of capturing images of object at different distances from the image capturing device using a number of focus modes accordingly, comprising:
a taking lens;
a memory for storing a movement range of the taking lens corresponding to each focus mode; and
a processing unit capable of controlling image capturing of the image capturing device, the processing unit comprising:
a receiving module capable of receiving a focus mode selected by a user;
a focusing module capable of performing auto-focus processing within the constraints of the focus mode selected by the user or auto-selected by the image capturing device;
a determining module capable of determining whether the current object able to be focused on using selected focus mode;
a selecting module for selecting a correct focus mode automatically according to the auto-focus processing by the focusing module, when there is a focus failure; and
an image capturing module for capturing an image in a correct focus mode selected by the user or auto-selected by the selecting module.

2. The image capturing device as claimed in claim 1, wherein image capturing device further comprises a monitor, the processing unit further comprises an outputting module for displaying focus failure information on the monitor, if the current object is determined out focus.

3. The image capturing device as claimed in claim 2, wherein the outputting module displays words on the monitor to display focus failing information.

4. The image capturing device as claimed in claim 2, wherein the outputting module changes the color of a focus frame of the image capturing device to indicate focus failure.

5. The image capturing device as claimed in claim 1, wherein the determining module determines whether the object is able to be focused on by analysis of a trend line of the changing contrast of an image sensed in the auto-focus processing.

6. The image capturing device as claimed in claim 1, wherein the image capturing device further comprises a shutter button, the auto focusing of the image capturing device is performed by half-pressing the shutter button and the image capturing of the image capturing device is performed by fully-pressing the shutter button.

7. The image capturing device as claimed in claim 1, wherein the focus modes of the image capturing device comprises a macro mode, a normal mode, and an infinity mode.

8. The image capturing device as claimed in claim 1, wherein the image capturing device is one selected from the group consisting of a still camera, a camcorder, and a mobile phone.

9. An image capturing method for an image capturing device, the image capturing device comprising a plurality of focus modes for capturing object at different distances from the image capturing device, the method comprising:
receiving a focus mode selected by a user;
performing auto-focus processing in the focus mode selected by the user;
determining whether the image capturing device is properly focused on a object in the selected focus mode;
selecting a correct focus mode automatically according to the decision made by the determining step;
performing auto-focus processing in the focus mode selected by the image capturing device automatically; and
capturing an image.

10. The method as claimed in claim 9, wherein the method further comprises a step of displaying focus failure information if the object is determined not properly focused.

11. The method as claimed in claim 9, wherein whether the image is in focus is determined by analysis of a trend line of the changing contrast of an image sensed in the auto-focus processing.

12. The method as claimed in claim 9, wherein the focus modes of the image capturing device comprises a macro mode, a normal mode, and an infinity mode.

13. The method as claimed in claim 9, wherein the image capturing device is one selected from the group consisting of a still camera, a video camera, and a mobile phone.
